(19) United States
(12) Patent Application Publication
(10) Pub. No.: US 2019/0031341 A1
(43) Pub. Date: Jan. 31, 2019

(54) UNIVERSAL CONTROLLER FOR ROBUST TRAJECTORY TRACKING IN MULTIROTOR UNMANNED AERIAL VEHICLES (UAVs)

(71) Applicant: Intel Corporation, Santa Clara, CA (US)

(72) Inventors: David Gomez Gutierrez, Tlaquepaque (MX); Maynard C. Falconer, Portland, OR (US)

(21) Appl. No.: 15/778,475

(22) PCT Filed: Dec. 22, 2015
(86) PCT No.: PCT/US2015/067532

§ 371 Date: May 23, 2018

(51) Int. Cl. B64C 39/02; B64C 27/08

(52) U.S. Cl. CPC B64C 39/024; B64C 27/08; B64C 2201/108; B64C 2201/128; B64C 2201/042; B64C 2201/141; B64C 2201/027

(57) ABSTRACT

A universal controller for robust trajectory tracking in multirotor unmanned aerial vehicles (UAVs) is disclosed. A particular embodiment includes: a sensor system to measure position and orientation of a multirotor unmanned aerial vehicle (UAV); and a flight control system, coupled to the sensor system, the flight control system being configured to: obtain position and orientation data from the sensor system; generate a plurality of derivatives from the position and orientation data using a differentiator; apply a decoupling control law to approximately decouple translation dynamics from each other in a three-dimensional (3D) space; compute error values between desired trajectories and actual trajectories in each dimension of 3D space using the plurality of derivatives and the decoupled dynamics; and generate control signals to vary speeds of a plurality of thrust elements to counteract the computed error values in each dimension of 3D space.

### TECHNICAL FIELD

This patent application relates to electronic systems, mobile devices, unmanned aerial vehicles (UAVs), and computer-implemented software, according to various example embodiments, and more specifically to a universal controller for robust trajectory tracking in multirotor unmanned aerial vehicles (UAVs).

### BACKGROUND

Autonomous systems, including drones, are a rapidly growing market that is finding applications in all aspects of our world (e.g., farms, warehouses, hospitals, commercial fishing, homes, offices, delivery, forestry management, disaster scenarios, and the like). Multirotor Unmanned Aerial Vehicles (UAVs), including multirotor aircraft like the quadrotor, are also a fast-growing field of aerial robotics. In fact, quadrotor aerial robotic vehicles have become a standard platform for robotics research worldwide. Quadrotors already have sufficient payload and flight endurance to support a number of indoor and outdoor applications. Battery improvements, autonomous operation, and other technologies are rapidly increasing the scope for commercial opportunities. However, the increase in indoor and outdoor applications also produces wider variability in the payloads and configurations of the UAVs. As a result, a significant amount of time and cost must be spent to re-configure, modify, and/or re-tune the UAV controller for variable payloads and configurations to maintain precise trajectory tracking for autonomous navigation.

### BRIEF DESCRIPTION OF THE DRAWINGS

The various embodiments are illustrated by way of example, and not by way of limitation, in the figures of the accompanying drawings in which:

FIGS. 1A, 1B, and 1C illustrate a conventional quadcopter, quadrotor, or multirotor UAV in relation to the dimensions of movement within which the UAV must be controlled;

FIG. 2 illustrates a conventional model-based control process for controlling a quadrotor;

FIGS. 3 and 4 illustrate a conventional Proportional-Integral-Derivative (PID) control process for controlling a quadrotor;

FIG. 5 illustrates a block diagram of a multirotor UAV and a ground controller according to an example embodiment;

FIG. 6 illustrates a block diagram of an example embodiment of the flight control system and the trajectory control logic according to an example embodiment;

FIG. 7 illustrates a parameter insensitive control process for controlling a multirotor UAV according to an example embodiment;

FIG. 8 is a processing flow chart illustrating an example embodiment of a method as described herein; and

FIG. 9 shows a diagrammatic representation of a machine in the example form of a mobile computing and/or communication system within which a set of instructions when executed and/or processing logic when activated may cause the machine to perform any one or more of the methodologies described and/or claimed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a universal controller for robust trajectory tracking in multirotor unmanned aerial vehicles (UAVs) are disclosed. Example embodiments are described wherein the UAV controller is configured to be insensitive to parametric variations in the UAV during autonomous flight of the UAV. As a result, the controller can be used with any multirotor UAV in a variety of applications with little or no modification, tuning, or re-configuration of the controller for autonomous operation. The various embodiments described herein improve the control design for a robust trajectory tracking controller so the improved controller does not require knowledge of the multirotor UAV system's parameters. The improved controller is thereby made to be insensitive to parametric variations in the UAV.

A few of the benefits of this improved controller are summarized below. Firstly, variable payloads or new features, such as cameras and/or batteries can be added to the UAV without the need to modify and/or re-tune of the controller while maintaining precise trajectory tracking for autonomous navigation. Secondly, by making the UAV controller insensitive to parametric variations (e.g., UAV system parameters, such as mass, size, payload, etc.), the improved controller can be used as a universal controller for each class of multirotor UAV without significant modification or re-tuning of the controller. Thirdly, the improved controller provides precise trajectory tracking that is robust and resilient to external disturbances.

The low cost of drones and UAVs together with their maneuverability and capabilities in navigation and mapping have enabled new outdoor and indoor applications. However, new and extended applications enable the UAV to become smarter and capable of autonomous operation. One key ingredient for autonomous operation is the ability to autonomously perform the precise maneuver planned by the pre-configured controller. Currently, methodologies for controlling the autonomous flight of multirotor UAVs require a precise modeling and characterization of the UAV system parameters (such as motors' thrust, inertias, mass, size, etc.) for the design of the proper controller. As features, such as different batteries, cameras, or payloads, are added to the UAV, the performance of the UAV begins to vary (mismatch) from the performance configured by the original precise modeling and characterization of the UAV system parameters. The performance of the UAV degrades without the proper (re-configured) modeling of the new system parameters, because of the mismatch from the model used in the original design. Although, methodologies for online identification and learning exist to cope with this problem, they often lead to a slow adaptation, resulting in ineffective control for agile maneuvers. The details of various example embodiments are provided below in connection with the accompanying figures.

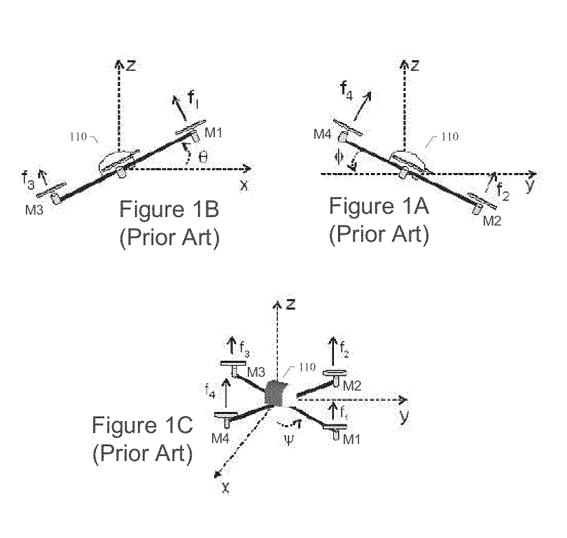

Turning now to FIGS. 1A, 1B, and 1C, a conventional quadcopter, quadrotor, or multirotor UAV is illustrated in relation to the dimensions of movement within which the UAV must be controlled. Although examples of a UAV with four rotors (thrust elements) are disclosed herein, it will be apparent to those of ordinary skill in the art that the disclosure herein similarly applies to multirotor UAV's having a quantity of thrust elements greater than or fewer than four. In the example shown in FIGS. 1A, 1B, and 1C, the quadrotor 110 consists of four individual rotors or thrust elements M1, M2, M3, and M4 attached to a rigid cross airframe. Typically, orientation and trajectory control of a quadrotor is achieved by differential control of the thrust generated by each thrust element.

A mathematical model of a quadcopter describes its attitude according to the well-known geometry of the typical UAV. More specifically as shown in FIGS. 1A, 1B, and 1C, the typical multirotor UAV consists of four thrust elements M1, M2, M3, and M4 located orthogonally along the rigid cross airframe. There are three movements that describe all possible combinations of attitude in a multirotor UAV. Roll movement ϕ (rotation around the X axis, see FIG. 1A) is obtained when the balance of thrust from thrust elements M2 and M4 is changed (e.g., speed increases or decreases). By changing the roll ϕ angle, lateral acceleration is obtained. Pitch movement θ (rotation around the Y axis, see FIG. 1B) is obtained when the balance of thrust from thrust elements M1 and M3 is changed. The pitch θ angle change results in a longitudinal acceleration. Yaw movement ψ (rotation about the Z axis, see FIG. 1C) is obtained by a simultaneous change in thrust from either the combination of thrust elements M1 and M3 or M2 and M4. As described in more detail below, these principles and techniques can be used for control of the orientation and position of the quadrotor in three dimensions to enable the quadrotor to acquire and track a desired or reference trajectory in a manner that is insensitive to quadrotor parameter variations.

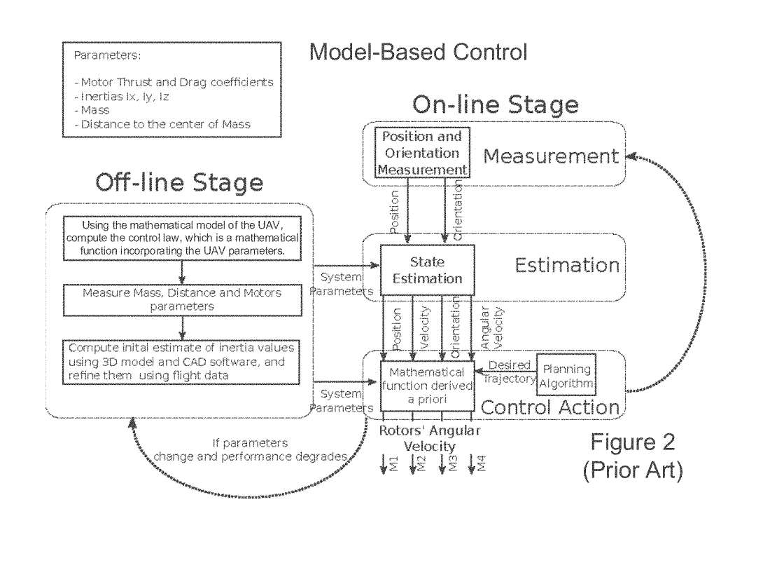

Referring now to FIG. 2, a conventional model-based control process for controlling a quadrotor is illustrated. The model-based control process uses a mathematical model to compute a control law for a specific UAV, which depends on the state and parameters of the specific UAV. As part of the model-based control process as shown in FIG. 2, a set of parameters associated with a particular UAV are estimated and defined in an off-line (i.e., non-flight) stage. Using a mathematical model of the UAV, a control law (e.g., a mathematical function that uses the state and the parameters of the particular UAV as part of its input) is computed a priori during the off-line stage. The mathematical model is obtained in part from the laws of physics using a well-known Newton-Euler method to describe the UAV's movement along a three-dimensional (3D) space as well as its orientation parameterized by Euler's angles, namely, pitch, roll, and yaw. For a given number of UAVs, the model among the different UAVs only varies by changing the mass, the length of the UAV (used to obtain the torques), the inertial matrix and the matrix of rotor parameters. To obtain a model-based control law, such UAV-specific parameters are usually measured (e.g., the mass, the airframe dimensions, the rotor parameters, etc.) or identified (e.g., the inertia matrix) off-line. Based on this model and the estimated UAV-specific parameters, a process for standard trajectory tracking control can be performed.

The control law is used during the on-line stage (i.e., a flight phase) by a flight controller to control the action of the UAV motors to achieve and maintain a desired flight trajectory. However, the control law will only be effective if the estimated parameters are close to the real or actual parameters of the particular UAV. If the parameters of the particular UAV are poorly estimated or significantly change and the actual parameters are significantly different from the estimated parameters, the off-line configuration process and control law generation needs to be repeated to obtain new parameters and a new control law that will used by the controller in the on-line stage. If the parameters and the related control law of a particular UAV deviate significantly from the actual parameters of the UAV, inefficiencies and instabilities in the performance of the UAV during flight will result.

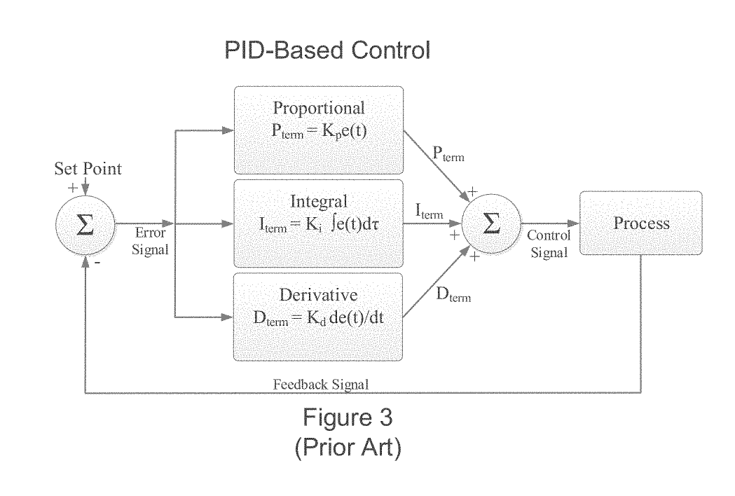

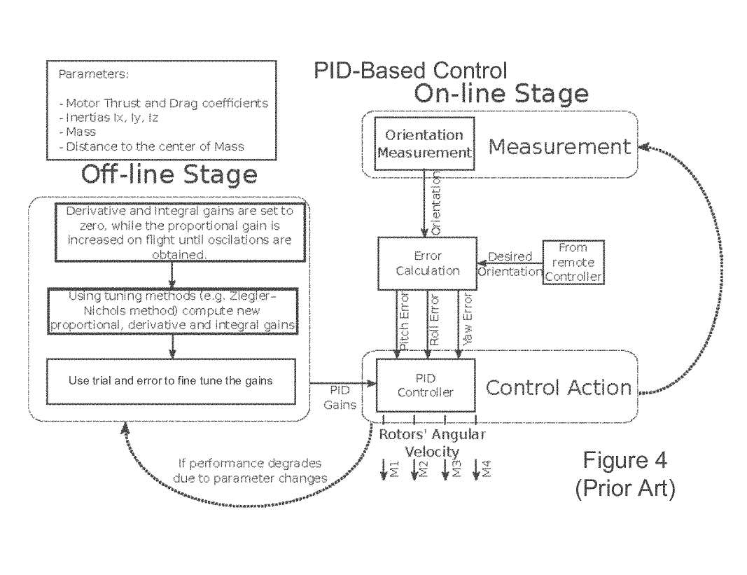

Referring now to FIGS. 3 and 4, a conventional Proportional-Integral-Derivative (PID) control process for controlling a quadrotor is illustrated. In a manner similar to the well-known model-based control process summarized above, the conventional PID UAV control process is still parameter dependent. As shown in FIG. 3, the PID control process generates proportional, integral, and derivative terms or PID gains, which are used by the PID control process to perform UAV control actions. As shown in FIG. 4, the PID control process still requires the definition of a set of UAV-specific parameters in an off-line stage. As explained above, these UAV-specific parameters can include motor thrust and drag coefficients, inertias (Ix, Iy, and Iz), UAV mass, UAV airframe dimensions, the rotor parameters, etc.). The UAV-specific parameters are used in an off-line process to derive the initial proportional, integral, and derivative terms (PID gains). PID control is used as an attitude controller (e.g., pitch, roll and yaw control) while navigation of the UAV is remote-controlled by a person using a ground controller. Using trial and error flight performance data and mathematical tuning methods, the PID gains are adjusted for each dynamic of the multirotor UAV (i.e., pitch, roll, and yaw) to work for a specific UAV with a specific parameter set. However, different UAV's with different specific UAV parameters will require different PID gains. PID control depends on the specific UAV parameters, as PID gains are different for each individual UAV. Thus, if there is a significant change in the UAV parameters, such as change in the mass of the UAV because of carrying a payload or adding features like cameras, the PID gains for the specific UAV will need to be re-tuned to maintain the efficiency and stability of the PID-controlled UAV.

The known methodologies for autonomous flight of a multirotor UAV, as described above, require either a detailed modeling and parameter configuration or a tedious and iterative tuning of the PID controller gains. In each case, the conventional methodologies are dependent upon the specific parameters associated with a particular UAV. Thus, the current methodologies provide UAV flight controllers that are UAV parameter dependent, sensitive to even slight parameter variations, and require careful design, configuration, and tuning of the controller for each different UAV design.

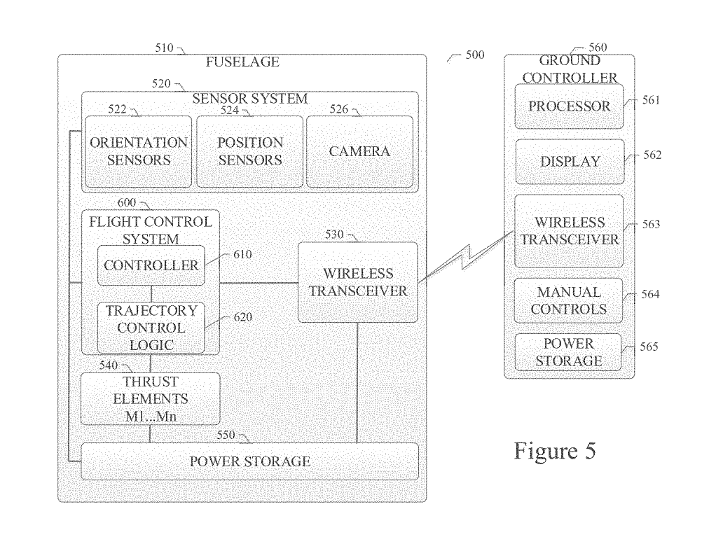

FIGS. 5 through 7 illustrate a block diagram and control process for a multirotor UAV 500, which may (or may not) be used with a ground controller 560 according to an example embodiment. The various embodiments described herein provide a precise trajectory tracking controller (an essential element for autonomous navigation) that is insensitive to UAV parameter variations. As a result, the example embodiments are not UAV parameter dependent and do not require specific UAV parameter configuration or iterative tuning. Thus, the various embodiments provide a UAV control system and process that is useful and efficient for a wide variety of different UAV types, sizes, and payloads without tedious recalibration.

With reference to FIG. 5, a UAV 500 according to an example embodiment can include a body serving as a central fuselage 510, and four (or more or less) propulsion arms extending laterally from a proximal end connected to the fuselage to a distal end. The UAV 500 of the example embodiment can include four (or more or less) electric motors 540 (e.g., M1, M2, M3, and M4). Each motor is attached to the distal end of a respective propulsion arm. Each motor has a rotor that is configured to be driven in rotation by the motor in an orientation (i.e., a rotational direction) that causes vertically downward thrust with respect to gravity when the UAV is in an upright orientation with respect to gravity (e.g., see FIG. 1C). The combination of the motor and the rotor form a thrust element configured to provide thrust in a primary direction of thrust with respect to the fuselage (e.g., along the vertical dimension).

In an example embodiment, the fuselage 510 can include a power source or power storage element 550 (e.g., a battery), a flight control system 600, and a sensor system 520 that includes orientation sensors 522, position sensors 524, (optionally) a camera 526. The flight control system 600 can further include a UAV wireless transceiver 530 to communicate wirelessly with a ground controller 560. The flight control system 600 is configured to control the speed at which the motors of the thrust elements (M1, M2, M3, and M4) 540 drive the rotors in rotation. In a particular embodiment, the flight control system 600 can be configured to reverse the direction of rotation of the rotors, and thus the motors can be configured to drive the rotors in either of two directions of rotation.

The flight control system 600 includes a controller 610 and trajectory control logic 620 configured to coordinate the operation of the thrust elements (M1, M2, M3, and M4) 540 to accomplish controlled flight in response to control signals from the flight control system 600. The controller 610 can be any of a variety of standard microcontrollers, microprocessors, chipsets, or other electronic control system. The trajectory control logic 620 includes an executable process, executable by the controller 610, for implementing a UAV-parameter insensitive UAV control system and process useful particularly for the autonomous operation of the UAV 500. The trajectory control logic 620 is described in more detail below.

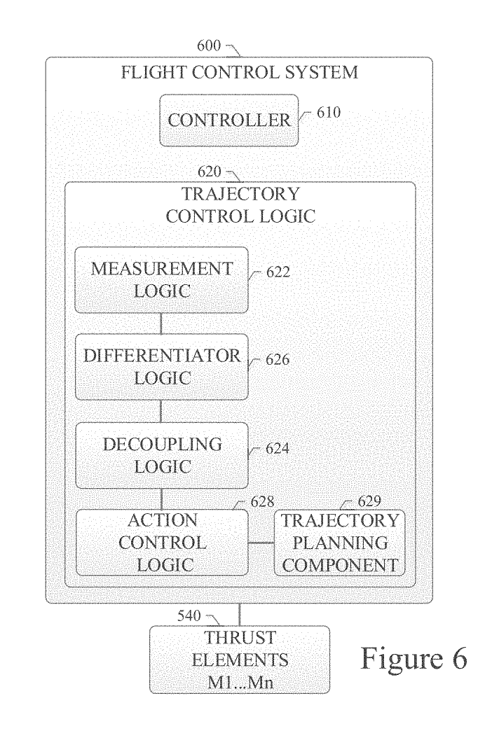

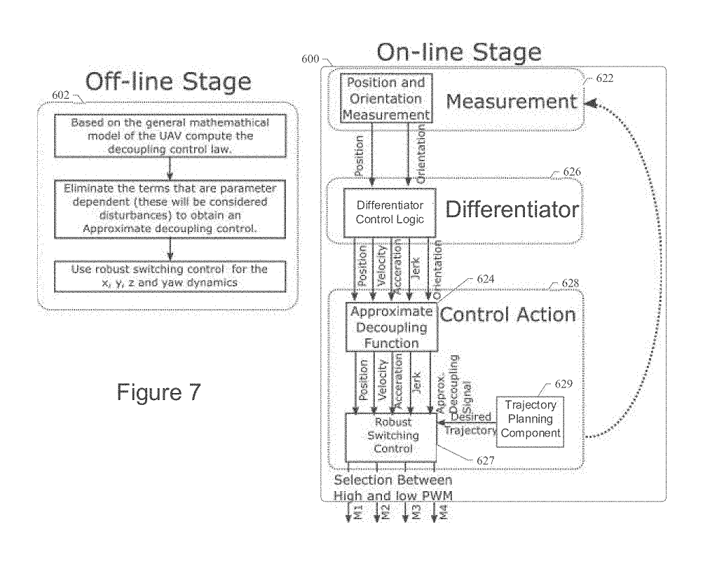

The flight control system 600 of an example embodiment can perform UAV control in either an autonomous mode or in response to manual instructions sent by a ground operator who is manipulating a ground controller 560 configured with a processor 561, a display 562 to display a video feed from the UAV camera 526, a wireless transceiver 563, manual controls 564, and a power source or power storage element (e.g., battery) 565. The manual controls 564 can be standard human-operated controls for manual flight, which may be in the form of an electronic or electromechanical device, such as a game controller or standard remote control transmitter. The ground controller wireless transceiver 563 is configured to communicate via a wireless connection with the UAV wireless transceiver 530 to send the ground operator's high-level flight control inputs to the UAV flight control system 600, and to receive information (such as a video feed) back from the UAV camera 526. Alternatively, in an autonomous mode, flight control inputs may be generated in response to automated instructions received by the flight control system 600 in the form of a trajectory plan provided by trajectory planning component 629 (shown in FIGS. 6 and 7) or other adaptive control program. The trajectory planning component 629 and/or the flight control system 600 may use sensor data provided by the orientation sensors 522 or from position sensors 524, such as a signal from a GPS (Global Positioning System) sensor. Typically, the instructions (whether manual or automated) processed by the flight control system 600 can be directed to high-level flight instructions (e.g., fly higher, fly forward, turn, and the like) and payload instructions (e.g., turn on the camera, pan the camera, and the like). The flight control system 600 is adapted to convert the high-level instructions into low-level instructions, such as instructions that activate individual motors of the thrust elements (M1 . . . M4) 540 at the desired rotor rotation rates and in the desired directions, or instructions that control the power delivered to the motors to accomplish that same purpose.

In the example embodiment during typical flight, all of the thrust elements 540 can create thrust in the primary direction of thrust, typically in the vertical dimension with respect to the fuselage 510. As described in more detail below, the flight control system 600 is further configured to control the speed of one or more motors of the thrust elements (M1, M2, M3, and M4) 540 such that the orientation of the fuselage 510 can be changed to effect a lateral acceleration (roll), a longitudinal acceleration (pitch), or a rotation about the Z axis (yaw). Thus, the UAV 500, at the direction of the flight control system 600, can adapt its primary direction of thrust relative to gravity based on UAV orientation. As described above in relation to FIGS. 1A, 1B, and 1C, roll movement ϕ (rotation around the X axis, see FIG. 1A) is obtained when the balance of thrust from thrust elements M2 and M4 is changed (e.g., speed increases or decreases). By changing the roll ϕ angle, lateral acceleration is obtained. Pitch movement θ (rotation around the Y axis, see FIG. 1B) is obtained when the balance of thrust from thrust elements M1 and M3 is changed. The pitch θ angle change results in a longitudinal acceleration. Yaw movement ψ (rotation about the Z axis, see FIG. 1C) is obtained by a simultaneous change in thrust from either the combination of thrust elements M1 and M3 or M2 and M4. As described in more detail below, the flight control system 600 can be used for control of the orientation and position of the UAV 500 in three dimensions to enable the UAV 500 to acquire and track a desired or reference trajectory in a manner that is insensitive to UAV 500 parameter variations.

FIG. 6 illustrates a block diagram of an example embodiment of the flight control system 600 and the trajectory control logic 620 according to an example embodiment. As described above, the flight control system 600 can be used for control of the orientation and position of the UAV 500 in three dimensions to enable the UAV 500 to acquire and track a desired or reference trajectory in a manner that is insensitive to UAV 500 parameter variations. The flight control system 600 of an example embodiment is configured to control the speed at which the motors of the thrust elements (M1, M2, M3, and M4) 540 drive the rotors in rotation. The flight control system 600 includes a controller 610 and trajectory control logic 620 configured to coordinate the operation of the thrust elements (M1, M2, M3, and M4) 540 to accomplish controlled flight in response to control signals from the flight control system 600. The flight control system 600 of an example embodiment can perform UAV control in either an autonomous mode or in response to manual instructions sent by a ground operator manipulating a ground controller 560. In an autonomous mode, the trajectory control logic 620 can generate control signals for the thrust elements 540 based on a trajectory plan provided by the trajectory planning component 629. As described in more detail below, the trajectory control logic 620 can determine the orientation and position of the UAV 500 in three dimensions and acquire and track a desired trajectory corresponding to the trajectory plan in a manner that is insensitive to UAV 500 parameter variations. This feature of the trajectory control logic 620 of an example embodiment is described in more detail below.

Referring still to FIG. 6, the trajectory control logic 620 of an example embodiment is shown to include measurement logic 622, differentiator logic 626, decoupling logic 624, and action control logic 628. As described above, the trajectory planning component 629 can provide a trajectory plan, which defines a desired trajectory. The measurement logic 622, differentiator logic 626, decoupling logic 624, and action control logic 628 are used to determine the actual trajectory of the UAV 500 in each dimension and to generate control signals to cause the actual trajectory of the UAV 500 to converge with the desired trajectory.

Measurement logic 622 can include logic for obtaining and pre-processing sensor data received from the various sensors included with the sensor system 520 on UAV 500. In an example embodiment, the sensor system 520 can include orientation sensors 522, position sensors 524, and (optionally) a camera 526. Orientation sensors 522 can include an accelerometer, gyroscope, a temperature sensor, pressure sensor, altimeter, an airspeed sensor, or any of a variety of other sensors useful for determining the orientation of the UAV 500. Position sensors 524 can include a GPS (Global Positioning System) sensor, a VHF Omni Directional Radio Range (VOR) receiver, automatic direction finder (ADF) receiver, celestial navigation system, or other standard methods for navigation. As shown in FIG. 7, the measurement logic component 622 can obtain the sensor data from the sensor system 520 and produce data or signals indicative of a current position and orientation of the UAV 500 at any point in time. The measurement logic component 622 can be configured to update the current UAV 500 position and orientation at a desired rate. The current UAV 500 position and orientation can be provided to the differentiator logic 626 and the decoupling logic 624 of the example embodiment. In a particular embodiment, the position and orientation data can be provided to differentiator logic 626 and decoupling logic 624 as (x, y, z) positions and Euler's angles (i.e., pitch, roll, and yaw), which can be obtained or derived from the data from the sensors of sensor system 520.

FIG. 7 illustrates a parameter insensitive control process for controlling a multirotor UAV according to an example embodiment. The parameter insensitive control process of the example embodiment can be performed by the trajectory control logic 620 shown in FIGS. 6 and 7. As shown in FIG. 7 and in contrast to the conventional quadrotor control processes described above, an initial set of off-line stage operations for the parameter insensitive control process of the example embodiment does not include the definition or tuning of UAV parameters or gain values. Instead, the parameter insensitive control process of the example embodiment can initially use the off-line stage to generate a general mathematical model that defines the approximate dynamics of the UAV 500 without regard to the particular parameters associated with a specific UAV. Any parameter-specific or parameter-dependent terms in the model are eliminated. As described in more detail below, the parameter-dependent terms are treated as disturbances that are corrected by the parameter insensitive control process. The result of the off-line stage is the generation of a decoupling control law that defines the approximate UAV 500 dynamics without regard to the specific parameters of the UAV 500. This decoupling control law can be used by the decoupling logic 624 as described in more detail below. Although the off-line generated decoupling control law cannot exactly model the dynamics of the UAV 500, the remaining operations of the parameter insensitive control process serve to correct the inaccuracies in the initially generated decoupling control law. These remaining operations are described in more detail below. It is also important to note that, unlike the conventional quadrotor control processes described above, the off-line stage operations of the example embodiment need to be performed only once for any multirotor UAV, not repeatedly or iteratively like the conventional methodologies.

Referring still to FIG. 7, the parameter insensitive control process of the example embodiment enables the trajectory control logic 620 to independently control the trajectories in 3D space (i.e., the movement over x, y and z) allowing the trajectory planning component 629 to produce desired trajectories independently for x, y, z, and yaw (as a function of time). As such, the parameter insensitive control process allows the UAV 500 to track a trajectory in 3D space, where reference trajectories for the position (x, y, z) and the yaw are followed independently. In the parameter insensitive control process of the example embodiment, the current UAV 500 position and its first four derivatives are used to predict the direction of movement and to compensate accordingly. In the example embodiment, the plurality of derivatives are generated from the UAV 500 position during the on-line stage operation of the differentiator logic 626 using a high order sliding mode differentiator. This plurality of derivatives can be denoted velocity, acceleration, jerk, and snap. The plurality of derivatives can be generated in the differentiator control logic of differentiator logic 626 as shown in FIG. 7. The differentiator logic 626 uses a recursive process for computing, during the online stage, the plurality of derivatives of the position, namely, velocity, acceleration, and jerk. These derivatives are used to predict the direction of movement of the UAV 500 and to maintain precise trajectory tracking. The plurality of derivatives generated by the differentiator logic 626 in the example embodiment can be provided to the decoupling logic 624 as shown in FIG. 7.

Once the decoupling control law is initially generated during the off-line stage as described above, the decoupling control law can be provided to the decoupling logic 624. As shown in FIG. 7, the decoupling logic 624 receives the position and orientation data from the measurement logic component 622 and the plurality of derivatives generated by the differentiator logic 626. The decoupling logic 624 uses the position and orientation data and the plurality of derivatives with the decoupling control law to produce independent trajectories in each dimension of three-dimensional (3D) space and an associated approximate decoupling signal. The decoupling logic 624 is a relaxation of a decoupling control used in model-based trajectory tracking (also known as non-interactive control), that unlike the traditional decoupling control, is parameter free. However, by virtue of the decoupling control being parameter free, the decoupling logic 624 is not able to exactly decouple the dynamics. The residual terms or excess coupling that remains after the application of the decoupling control law by the decoupling logic 624 is treated as a disturbance to be rejected (or compensated for) by the switching control component 627. This excess coupling is encoded as the approximate decoupling signal. The position, the plurality of derivatives generated by the differentiator logic 626, and the approximate decoupling signal generated by the decoupling logic 624 can be provided to the switching control component 627 of the action control logic 628. The switching control component 627 can use the approximate decoupling signal with the position and its plurality of derivatives produced by the differentiator logic 626 to maintain the UAV 500 on the desired trajectory by compensating for the excess coupling defined by the approximate decoupling signal. The trajectory is a function of time; thus, there is a time associated with each desired position of the desired trajectory as obtained from the trajectory planning component 629. As such, the time and position data associated with the desired trajectory can be obtained or generated by the trajectory planning component 629 and provided to the switching control component 627 to enable the switching control component 627 to maintain the UAV 500 on the desired trajectory.

In the example embodiment, the action control logic 628 and the switching control component 627 therein can use the position and orientation information, including pitch, roll, and yaw, which are obtained from the measurement logic component 622, together with the plurality of derivatives of the position (i.e., velocity, acceleration, jerk, and snap) in the direction of interest (x, y, or z) and the approximate decoupling signal to compute error values between the desired trajectories (provided by the trajectory planning component 629) and the actual trajectories in each of the independent dimensions. The action control logic 628 can further generate control signals to vary the speeds of the thrust elements 540 to counteract the error values computed earlier for each of the dimensions. As a result, the action control logic 628 can operate to cause the actual trajectories of the UAV 500 in each of the dimensions to converge on the desired trajectories. In a particular embodiment, instead of computing the exact angular velocities for each of the thrust elements 540, the action control logic 628 can generate control signals to quickly switch any of the motors of the thrust elements 540 between a high speed value and a low speed value. The two speed values (high and low) can be encoded into a pulse width modulated (PWM) signal to produce a fast reacting signal. Therefore, the movement of the UAV 500 can react quickly to new position and orientation measurements and the associated desired trajectories.

In the example embodiments as described herein, instead of exactly cancelling the undesired dynamics and perfectly decoupling the dynamics, the example embodiment approximates the decoupled dynamics, thereby creating residual terms or excess coupling that may be parameter dependent. Such residual terms are treated as unknown disturbances that are rejected or counteracted by the parameter insensitive control process of an example embodiment. As a result, the parameter insensitive control process can eliminate the parameter dependence of the control design by treating the terms that are parameter dependent as unknown disturbances that are counteracted by the control process to achieve trajectory tracking with unknown parameters. In this manner, the parameter insensitive control process of the various embodiments can be used with a wide variety of UAVs without tedious reconfiguration and retuning of parameters or gains.

Compared to existing solutions, the embodiments as described herein provide a variety of advantages. Firstly, the parameter insensitive control process as described herein provides a universal controller for multiple classes of multirotor UAVs. This allows the use of the same controller on a wide variety of UAVs of different sizes and weights and without the need for careful tuning of the controller for each different UAV. Secondly, the parameter insensitive control process as described herein provides a trajectory tracking controller that is insensitive to parametric variations of the UAV. This allows one to add components or reconfigure components of the UAV without compromising the precision of the trajectory tracking and without requiring additional tuning as required with current methodologies. Thirdly, the parameter insensitive control process as described herein provides precise trajectory tracking that is robust and resilient to external disturbances.

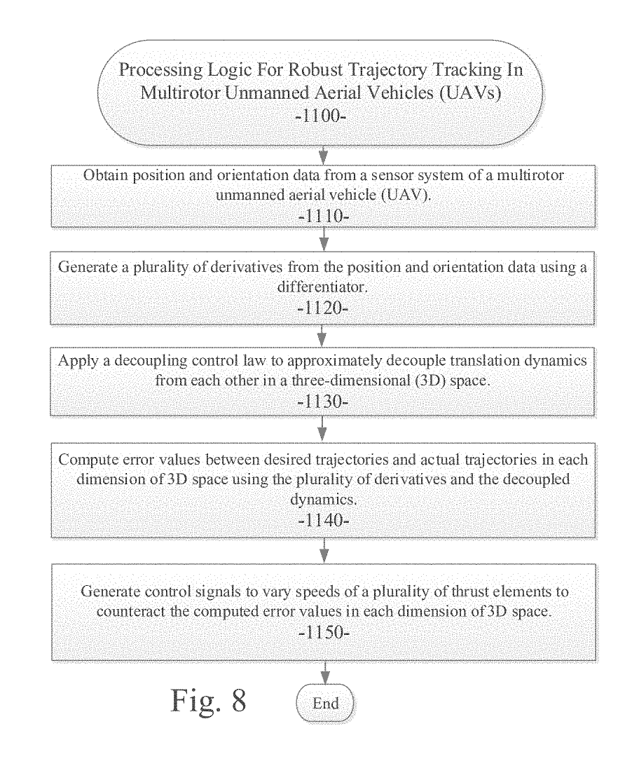

Referring now to FIG. 8, a processing flow diagram illustrates an example embodiment of a method 1100 as described herein. The method 1100 of an example embodiment includes: obtaining position and orientation data from a sensor system of a multirotor unmanned aerial vehicle (UAV) (processing block 1110); generating a plurality of derivatives from the position and orientation data using a differentiator (processing block 1120); applying a decoupling control law to approximately decouple translation dynamics from each other in a three-dimensional (3D) space (processing block 1130); computing error values between desired trajectories and actual trajectories in each dimension of 3D space using the plurality of derivatives and the decoupled dynamics (processing block 1140); and generating control signals to vary speeds of a plurality of thrust elements to counteract the computed error values in each dimension of 3D space (processing block 1150).

Embodiments described herein are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size can be manufactured. In addition, well-known power/ground connections to integrated circuit (IC) chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one of ordinary skill in the art. Where specific details (e.g., circuits) are set forth in order to describe example embodiments, it should be apparent to one of ordinary skill in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

UAV 500 may include one or more wireless transceivers, in some embodiments. Each of the wireless transceivers may be implemented as physical wireless adapters or virtual wireless adapters, sometimes referred to as “hardware radios” and “software radios,” respectively. A single physical wireless adapter may be virtualized (e.g., using software) into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smartphone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The example embodiments described herein are not limited in this respect.

The wireless transceivers may include or implement various communication techniques to allow the UAV 500 to communicate with other electronic devices, such as ground controller 560. For instance, the wireless transceivers may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth.

By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other parts of the spectrum, and other wireless media.

In various embodiments, the UAV 500 may implement different types of wireless transceivers. Each of the wireless transceivers may implement or utilize a same or different set of communication parameters to communicate information between various electronic devices. In one embodiment, for example, each of the wireless transceivers may implement or utilize a different set of communication parameters to communicate information between UAV 500 and any number of other devices. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the wireless transceivers. The example embodiments described herein are not limited in this respect.

In various embodiments, the wireless transceivers may implement different communication parameters offering varying bandwidths, communications speeds, or transmission ranges. For instance, a first wireless transceiver may include a short-range interface implementing suitable communication parameters for shorter range communication of information, while a second wireless transceiver may include a long-range interface implementing suitable communication parameters for longer range communication of information.

In various embodiments, the terms “short-range” and “long-range” may be relative terms referring to associated communications ranges (or distances) for associated wireless transceivers as compared to each other rather than an objective standard. In one embodiment, for example, the term “short-range” may refer to a communications range or distance for the first wireless transceiver that is shorter than a communications range or distance for another wireless transceiver implemented for UAV 500, such as a second wireless transceiver. Similarly, the term “long-range” may refer to a communications range or distance for the second wireless transceiver that is longer than a communications range or distance for another wireless transceiver implemented for the UAV 500, such as the first wireless transceiver. The example embodiments described herein are not limited in this respect.

In one embodiment, for example, the wireless transceiver may include a radio designed to communicate information over a wireless personal area network (WPAN) or a wireless local area network (WLAN). The wireless transceiver may be arranged to provide data communications functionality in accordance with different types of lower range wireless network systems or protocols. Examples of suitable WPAN systems offering lower range data communication services may include a Bluetooth™ system as defined by the Bluetooth Special Interest Group, an infra-red (IR) system, an Institute of Electrical and Electronics Engineers (IEEE™) 802.15 system, a DASH7 system, wireless universal serial bus (USB), wireless high-definition (HD), an ultra-side band (UWB) system, and similar systems. Examples of suitable WLAN systems offering lower range data communications services may include the IEEE 802.xx series of protocols, such as the IEEE 802.11a/b/g/n series of standard protocols and variants (also referred to as “WiFi”). It may be appreciated that other wireless techniques may be implemented. The example embodiments described herein are not limited in this respect. In one embodiment, for example, the wireless transceiver may include a radio designed to communicate information over a wireless metropolitan area network (WMAN), a wireless wide area network (WWAN), or a cellular radiotelephone system. Another wireless transceiver may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the wireless transceiver may include a radio designed to communicate information across data networking links provided by one or more cellular radiotelephone systems. Examples of cellular radiotelephone systems offering data communications services may include GSM with General Packet Radio Service (GPRS) systems (GSM/GPRS), CDMA/1×RTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented. The example embodiments described herein are not limited in this respect.

Although not shown, UAV 500 may further include one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control logic, an input/output (I/O) device, computer-readable media, network interfaces, portable power supplies (e.g., a battery), application programs, system programs, and so forth. The example embodiments described herein are not limited in this respect.

Included herein is a set of logic flows representative of example methodologies for performing novel aspects of the disclosed architecture. While, for purposes of simplicity of explanation, the one or more methodologies shown herein are shown and described as a series of acts, those of ordinary skill in the art will understand and appreciate that the methodologies are not limited by the order of acts. Some acts may, in accordance therewith, occur in a different order and/or concurrently with other acts from those shown and described herein. For example, those of ordinary skill in the art will understand and appreciate that a methodology can alternatively be represented as a series of interrelated states or events, such as in a state diagram. Moreover, not all acts illustrated in a methodology may be required for a novel implementation. A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The example embodiments disclosed herein are not limited in this respect.

The various elements of the example embodiments as previously described with reference to the figures may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The example embodiments described herein provide a technical solution to a technical problem. The various embodiments improve the functioning of the electronic device by providing systems and methods for controlling the orientation and trajectory of a multirotor UAV in a manner that is insensitive to UAV parameters. The various embodiments also serve to transform the state of various system components based on a dynamically determined system context. Additionally, the various embodiments effect an improvement in a variety of technical fields including the fields of dynamic data processing, drone control, mobile computing, information sharing, and mobile communications.

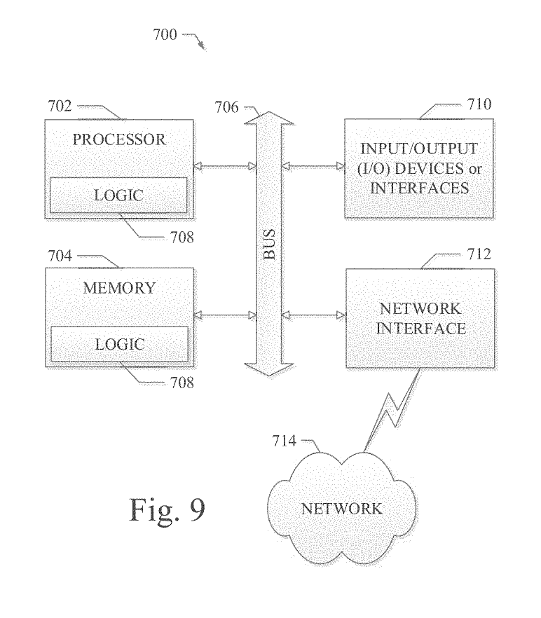

FIG. 9 shows a diagrammatic representation of a machine in the example form of an electronic device, such as a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip [SoC], general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

With general reference to notations and nomenclature used herein, the description presented herein may be disclosed in terms of program procedures executed on a computer or a network of computers. These procedural descriptions and representations may be used by those of ordinary skill in the art to convey their work to others of ordinary skill in the art.

A procedure is generally conceived to be a self-consistent sequence of operations performed on electrical, magnetic, or optical signals capable of being stored, transferred, combined, compared, and otherwise manipulated. These signals may be referred to as bits, values, elements, symbols, characters, terms, numbers, or the like. It should be noted, however, that all of these and similar terms are to be associated with the appropriate physical quantities and are merely convenient labels applied to those quantities. Further, the manipulations performed are often referred to in terms such as adding or comparing, which operations may be executed by one or more machines. Useful machines for performing operations of various embodiments may include general-purpose digital computers or similar devices. Various embodiments also relate to apparatus or systems for performing these operations. This apparatus may be specially constructed for a purpose, or it may include a general-purpose computer as selectively activated or reconfigured by a computer program stored in the computer. The procedures presented herein are not inherently related to a particular computer or other apparatus. Various general-purpose machines may be used with programs written in accordance with teachings herein, or it may prove convenient to construct more specialized apparatus to perform methods described herein.

In various embodiments as described herein, example embodiments include at least the following examples.

An apparatus comprising: a sensor system to measure position and orientation of a multirotor unmanned aerial vehicle (UAV); and a flight control system, coupled to the sensor system, the flight control system being configured to: obtain position and orientation data from the sensor system; generate a plurality of derivatives from the position and orientation data using a differentiator; apply a decoupling control law to approximately decouple translation dynamics from each other in a three-dimensional (3D) space; compute error values between desired trajectories and actual trajectories in each dimension of 3D space using the plurality of derivatives and the decoupled dynamics; and generate control signals to vary speeds of a plurality of thrust elements to counteract the computed error values in each dimension of 3D space.

The apparatus as claimed above wherein the sensor system includes orientation sensors and position sensors.

The apparatus as claimed above wherein the plurality of thrust elements corresponds to four thrust elements.

The apparatus as claimed above wherein the position and orientation data includes pitch, roll, and yaw.

The apparatus as claimed above wherein the plurality of derivatives are generated using a high order sliding mode differentiator.

The apparatus as claimed above wherein the desired trajectories are obtained from a trajectory planning logic component.

The apparatus as claimed above being further configured to generate control signals to switch any of the plurality of thrust elements between a high speed value and a low speed value using a pulse width modulated (PWM) signal.

A system comprising: a fuselage; a power storage element; a sensor system to measure position and orientation of a multirotor unmanned aerial vehicle (UAV); a plurality of thrust elements; and a flight control system, coupled to the sensor system and the plurality of thrust elements, the flight control system being configured to: obtain position and orientation data from the sensor system; generate a plurality of derivatives from the position and orientation data using a differentiator; apply a decoupling control law to approximately decouple translation dynamics from each other in a three-dimensional (3D) space; compute error values between desired trajectories and actual trajectories in each dimension of 3D space using the plurality of derivatives and the decoupled dynamics; and generate control signals to vary speeds of the plurality of thrust elements to counteract the computed error values in each dimension of 3D space.

The system as claimed above wherein the sensor system includes orientation sensors and position sensors.

The system as claimed above wherein the plurality of thrust elements corresponds to four thrust elements.

The system as claimed above wherein the position and orientation data includes pitch, roll, and yaw.

The system as claimed above wherein the plurality of derivatives are generated using a high order sliding mode differentiator.

The system as claimed above wherein the desired trajectories are obtained from a trajectory planning logic component.

The system as claimed above being further configured to generate control signals to switch any of the plurality of thrust elements between a high speed value and a low speed value using a pulse width modulated (PWM) signal.

A method comprising: obtaining position and orientation data from a sensor system of a multirotor unmanned aerial vehicle (UAV); generating a plurality of derivatives from the position and orientation data using a differentiator; applying a decoupling control law to approximately decouple translation dynamics from each other in a three-dimensional (3D) space; computing error values between desired trajectories and actual trajectories in each dimension of 3D space using the plurality of derivatives and the decoupled dynamics; and generating control signals to vary speeds of a plurality of thrust elements to counteract the computed error values in each dimension of 3D space.

The method as claimed above wherein the sensor system includes orientation sensors and position sensors.

The method as claimed above wherein the plurality of thrust elements corresponds to four thrust elements.

The method as claimed above wherein the position and orientation data includes pitch, roll, and yaw.

The method as claimed above wherein the plurality of derivatives are generated using a high order sliding mode differentiator.

The method as claimed above wherein the desired trajectories are obtained from a trajectory planning logic component.

The method as claimed above including generating control signals to switch any of the plurality of thrust elements between a high speed value and a low speed value using a pulse width modulated (PWM) signal.

A non-transitory machine-useable storage medium embodying instructions which, when executed by a machine, cause the machine to: obtain position and orientation data from a sensor system of a multirotor unmanned aerial vehicle (UAV); generate a plurality of derivatives from the position and orientation data using a differentiator; apply a decoupling control law to approximately decouple translation dynamics from each other in a three-dimensional (3D) space; compute error values between desired trajectories and actual trajectories in each dimension of 3D space using the plurality of derivatives and the decoupled dynamics; and generate control signals to vary speeds of a plurality of thrust elements to counteract the computed error values in each dimension of 3D space.

The machine-useable storage medium as claimed above wherein the sensor system includes orientation sensors and position sensors.

The machine-useable storage medium as claimed above wherein the plurality of thrust elements corresponds to four thrust elements.

The machine-useable storage medium as claimed above wherein the position and orientation data includes pitch, roll, and yaw.

The machine-useable storage medium as claimed above wherein the instructions are configured to generate the plurality of derivatives using a high order sliding mode differentiator.

The machine-useable storage medium as claimed above wherein the instructions are configured to obtain the desired trajectories from a trajectory planning logic component.

The machine-useable storage medium as claimed above wherein the instructions are configured to generate control signals to switch any of the plurality of thrust elements between a high speed value and a low speed value using a pulse width modulated (PWM) signal.

An apparatus comprising: a sensing means to measure position and orientation of a multirotor unmanned aerial vehicle (UAV); and a flight controlling means, coupled to the sensing means, the flight controlling means being configured to: obtain position and orientation data from the sensing means; generate a plurality of derivatives from the position and orientation data using a differentiator; apply a decoupling control law to approximately decouple translation dynamics from each other in a three-dimensional (3D) space; compute error values between desired trajectories and actual trajectories in each dimension of 3D space using the plurality of derivatives and the decoupled dynamics; and generate control signals to vary speeds of a plurality of thrust elements to counteract the computed error values in each dimension of 3D space.

The apparatus as claimed above wherein the sensing means includes orientation sensors and position sensors.

The apparatus as claimed above wherein the plurality of thrust elements corresponds to four thrust elements.

The apparatus as claimed above wherein the position and orientation data includes pitch, roll, and yaw.

The apparatus as claimed above wherein the plurality of derivatives are generated using a high order sliding mode differentiator.

The apparatus as claimed above wherein the desired trajectories are obtained from a trajectory planning logic component.

The apparatus as claimed above being further configured to generate control signals to switch any of the plurality of thrust elements between a high speed value and a low speed value using a pulse width modulated (PWM) signal.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus comprising:
a sensor system to measure position and orientation of a multirotor unmanned aerial vehicle (UAV); and
a flight control system, coupled to the sensor system, the flight control system to:
obtain position and orientation data from the sensor system;
generate a plurality of derivatives from the position and orientation data using a differentiator;
apply a decoupling control law to approximately decouple translation dynamics from each other in a three-dimensional (3D) space;
compute error values between desired trajectories and actual trajectories in each dimension of 3D space using the plurality of derivatives and the decoupled translation dynamics; and
generate control signals to vary speeds of a plurality of thrust elements to counteract the computed error values in each dimension of 3D space.

2. The apparatus of claim 1, wherein the position and orientation data includes pitch, roll, and yaw.

3. The apparatus of claim 1, wherein the plurality of derivatives are to be generated using a high order sliding mode differentiator.

4. The apparatus of claim 1, wherein the desired trajectories are to be obtained from a trajectory planning logic component.

5. The apparatus of claim 1, wherein the flight control system is to generate control signals to switch any of the plurality of thrust elements between a high speed value and a low speed value using a pulse width modulated (PWM) signal.

6. A system comprising:
a fuselage;
a power storage element;
a sensor system to measure position and orientation of a multirotor unmanned aerial vehicle (UAV);
a plurality of thrust elements; and
a flight control system, coupled to the sensor system and the plurality of thrust elements, the flight control system to:
obtain position and orientation data from the sensor system;
generate a plurality of derivatives from the position and orientation data using a differentiator;
apply a decoupling control law to approximately decouple translation dynamics from each other in a three-dimensional (3D) space;
compute error values between desired trajectories and actual trajectories in each dimension of 3D space using the plurality of derivatives and the decoupled translation dynamics; and
generate control signals to vary speeds of the plurality of thrust elements to counteract the computed error values in each dimension of 3D space.

7. The system of claim 6, wherein the position and orientation data includes pitch, roll, and yaw.

8. The system of claim 6, wherein the plurality of derivatives are to be generated using a high order sliding mode differentiator.

9. The system of claim 6, wherein the desired trajectories are to be obtained from a trajectory planning logic component.

10. The system of claim 6, wherein the flight control system is to further generate control signals to switch any of the plurality of thrust elements between a high speed value and a low speed value using a pulse width modulated (PWM) signal.

11. A method comprising:
obtaining position and orientation data from a sensor system of a multirotor unmanned aerial vehicle (UAV);
generating a plurality of derivatives from the position and orientation data using a differentiator;
applying a decoupling control law to approximately decouple translation dynamics from each other in a three-dimensional (3D) space;
computing error values between desired trajectories and actual trajectories in each dimension of 3D space using the plurality of derivatives and the decoupled translation dynamics; and
generating control signals to vary speeds of a plurality of thrust elements to counteract the computed error values in each dimension of 3D space.

12. The method of claim 11, wherein the position and orientation data includes pitch, roll, and yaw.

13. The method of claim 11, wherein the plurality of derivatives are generated using a high order sliding mode differentiator.

14. The method of claim 11, wherein the desired trajectories are obtained from a trajectory planning logic component.

15. The method of claim 11, further including generating control signals to switch any of the plurality of thrust elements between a high speed value and a low speed value using a pulse width modulated (PWM) signal.

16. A non-transitory machine-useable storage medium comprising instructions which, when executed by a processor, cause the processor to:
obtain position and orientation data from a sensor system of a multirotor unmanned aerial vehicle (UAV);
generate a plurality of derivatives from the position and orientation data using a differentiator;
apply a decoupling control law to approximately decouple translation dynamics from each other in a three-dimensional (3D) space;
compute error values between desired trajectories and actual trajectories in each dimension of 3D space using the plurality of derivatives and the decoupled translation dynamics; and
generate control signals to vary speeds of a plurality of thrust elements to counteract the computed error values in each dimension of 3D space.

17. The machine-useable storage medium of claim 16, wherein the position and orientation data includes pitch, roll, and yaw.

18. The machine-useable storage medium of claim 16, wherein the instructions are to cause the processor to generate the plurality of derivatives using a high order sliding mode differentiator.

19. The machine-useable storage medium of claim 16, wherein the instructions are to cause the processor to obtain the desired trajectories from a trajectory planning logic component.

20. The machine-useable storage medium of claim 16, wherein the instructions are to cause the processor to generate control signals to switch any of the plurality of thrust elements between a high speed value and a low speed value using a pulse width modulated (PWM) signal.

21. An apparatus comprising:
a sensing means to measure position and orientation of a multirotor unmanned aerial vehicle (UAV); and
a flight controlling means, coupled to the sensing means, the flight controlling means to:
obtain position and orientation data from the sensing means;
generate a plurality of derivatives from the position and orientation data using a differentiator;
apply a decoupling control law to approximately decouple translation dynamics from each other in a three-dimensional (3D) space;
compute error values between desired trajectories and actual trajectories in each dimension of 3D space using the plurality of derivatives and the decoupled translation dynamics; and
generate control signals to vary speeds of a plurality of thrust elements to counteract the computed error values in each dimension of 3D space.

22. The apparatus of claim 21, wherein the position and orientation data includes pitch, roll, and yaw.

23. The apparatus of claim 21, wherein the plurality of derivatives are generated using a high order sliding mode differentiator.

24. The apparatus of claim 21, wherein the desired trajectories are obtained from a trajectory planning logic component.

25. The apparatus of claim 21, wherein the flight controlling means is to generate control signals to switch any of the plurality of thrust elements between a high speed value and a low speed value using a pulse width modulated (PWM) signal.
